(19) United States
(12) Patent Application Publication
(10) Pub. No.: US 2019/0157846 A1
(43) Pub. Date: May 23, 2019

(54) CONNECTOR PLUG FOR CONNECTING AN IGNITION COIL TO A SPARK PLUG

(71) Applicant: BorgWarner Ludwigsburg GmbH, Ludwigsburg (DE)

(72) Inventors: Sven Schumm, Walheim (DE); Manfred Adolf, Schwaikheim (DE); Manuel Bauer, Ludwigsburg (DE); Dirk Wüstenhagen, Auma (DE); Alexander Stark, Althengstett (DE)

(21) Appl. No.: 16/190,428

(22) Filed: Nov. 14, 2018

(30) Foreign Application Priority Data
Nov. 17, 2017 (DE) 10 2017 127 174.0
Apr. 9, 2018 (DE) 10 2018 108 292.4

(51) Int. Cl. H01T 13/04; H01F 38/12; H01F 27/28; F02P 3/02

(52) U.S. Cl. CPC H01T 13/04; F02P 3/02; H01F 27/2828; H01F 38/12

(57) ABSTRACT

A connector plug is described for connecting an ignition coil to a spark plug, comprising an electrical conductor, which has a first end for contacting the ignition coil and a second end for contacting the spark plug, and a protective tube, which surrounds the electrical conductor. In accordance with this disclosure it is proposed that the protective tube has a predetermined bending point with a reduced bending stiffness.

### RELATED APPLICATIONS

This application claims priority to DE 10 2017 127 174.0, filed Nov. 17, 2017, and also claims priority to DE 10 2018 108 292.4, filed Apr. 9, 2018, both of which are incorporated herein by reference in their entirety.

### BACKGROUND AND SUMMARY

This disclosure is based on a connector plug for connecting an ignition coil to a spark plug. Connector plugs of this type are generally known from DE 10 2011 082 231 A1, JP 2011-134857 A and DE 10 2015 110 309 A1, for example.

Depending on the geometric conditions on an engine, connector plugs with either a straight or a curved protective tube are required. The production of both straight and curved protective tubes is expensive. There is therefore a need for connector plugs that can be bent as required, such as the connector plug of known art from JP 2011-134857 A.

This disclosure shows how a connector plug for connecting a spark plug to an ignition coil can be produced cost-effectively, which—if required—can also be mounted in a curved state on an engine with little effort, and is protected from damage by a mechanically robust protective tube.

The protective tube of an inventive connector plug has a predetermined bending point with a reduced bending stiffness. If the connector plug is to be used in a curved state, the protective tube can easily be bent in the desired manner at the one or more bending points, so that the connector plug can be used in either a straight configuration or a curved configuration. In the simplest case, the predetermined bending point can be embodied as a groove or a notch in the outer surface of the protective tube.

In an advantageous refinement of this disclosure the protective tube has a plurality of mutually adjacent reinforcement ribs extending in its longitudinal direction, wherein the predetermined bending point is designed as a recess, or other weakening feature, in one or a plurality of these reinforcement ribs. All the reinforcement ribs, some of the reinforcement ribs, or even just one reinforcement rib, may have such a recess.

It is preferable that reinforcement ribs on opposite sides of the protective tube have a predetermined bending point in the form of a recess, but that reinforcement ribs located in between them have no recess. In this manner, the bending stiffness of the protective tube is reduced only where it is necessary, namely on the inner and outer radius of the intended bend.

The protective tube can have, for example, four reinforcement ribs, wherein two opposing reinforcement ribs have the predetermined bending point, and the two reinforcement ribs located in between them have no predetermined bending point at the corresponding position. The recess forming a predetermined bending point can, for example, be designed in the form of a notch, a rectangular shape, or a U-shaped recess.

In another advantageous refinement of this disclosure the outer surface of the protective tube is closed in the vicinity of the predetermined bending point. In this manner, the protective function of the protective tube is not impaired by the predetermined bending point. In particular, the protective tube can then also fulfil the function of electrical insulation such that no additional electrical insulation is required. In principle, the protective tube can, however, also fulfil its function, albeit to a limited extent, if the predetermined bending point forms an opening in the outer surface of the protective tube, for example a slot passing through its wall.

In another advantageous refinement the protective tube has, at a distance from the predetermined bending point, a section that has an increased wall thickness. In the vicinity of the predetermined bending point, on the other hand, the wall thickness of the protective tube between the reinforcement ribs can be reduced.

The protective tube of an inventive connector plug can have a plurality of predetermined bending points, which are arranged at a distance from each other in the axial direction. However, the protective tube preferably only has one predetermined bending point at one height.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an example of embodiment of an inventive connector plug;

FIG. 2 shows the connector plug shown in FIG. 1 in a curved state;

FIG. 3 shows another example of embodiment of a protective tube for a connector plug;

FIG. 4 shows a detail of FIG. 3; and

FIG. 5 shows a cross-sectional view of the protective tube shown in FIG. 3 in a curved state.

### DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

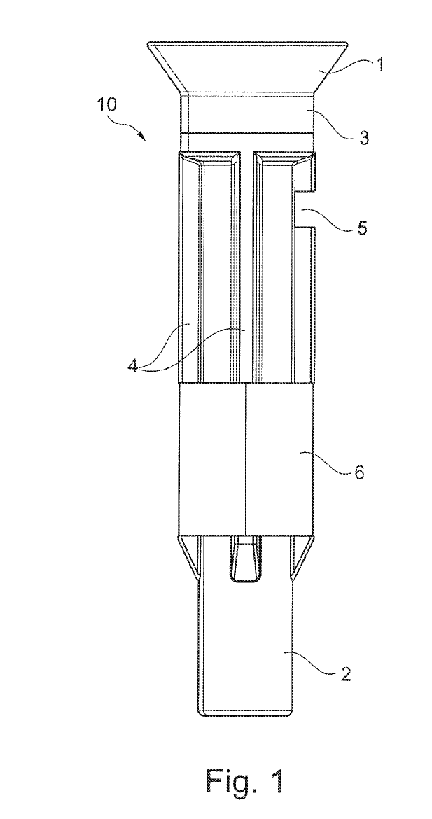

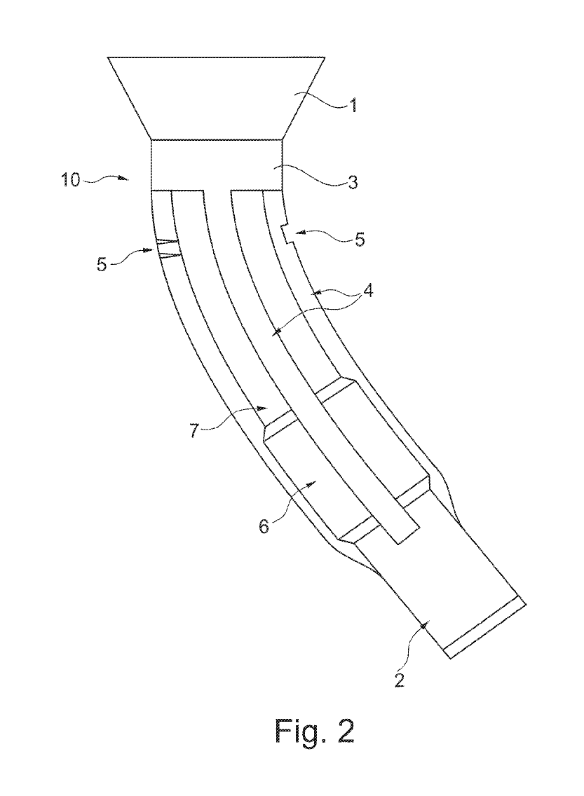

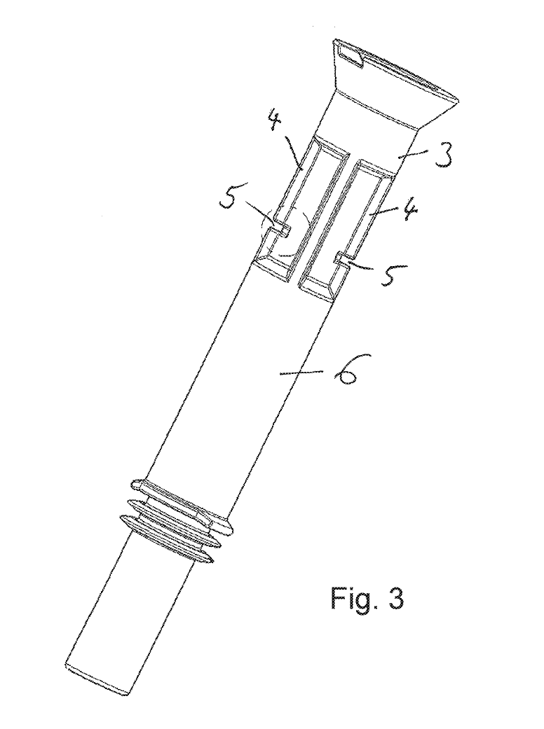

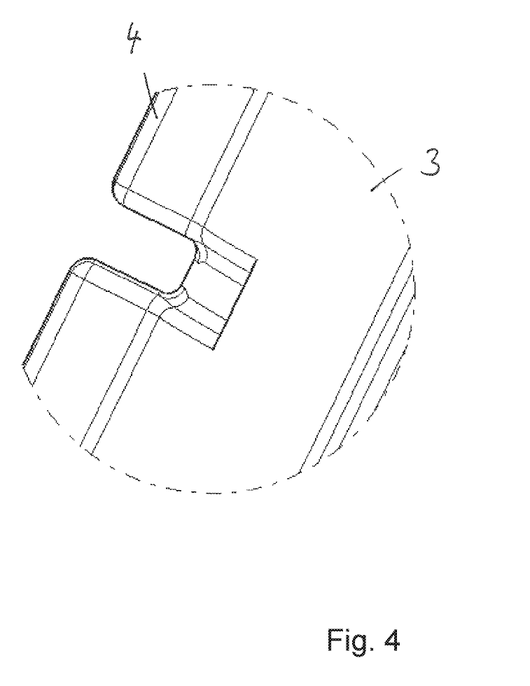

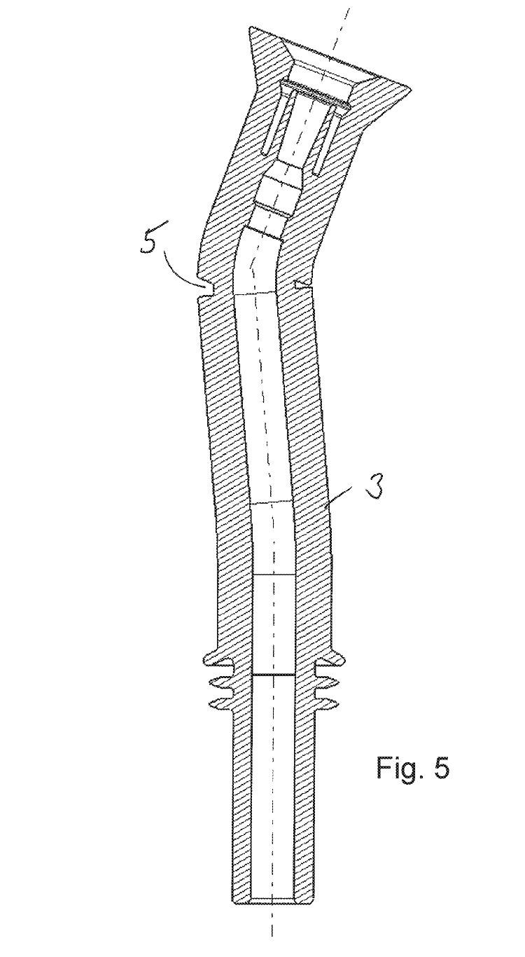

The connector plug 10 shown in FIG. 1 is used to connect an ignition coil to a spark plug of an internal combustion engine. For this purpose, the upper end 1 of the connector plug 10 in the figures is connected to the ignition coil, and the lower end 2 in the figures is connected to the spark plug. The connector plug 10 contains an electrical conductor, for example in the form of a metallic coil spring, which is surrounded by a protective tube 3, and in operation connects the high-voltage contact of an ignition coil to the terminal contact of a spark plug in an electrically conducting manner. The protective tube 3 can be seen in FIGS. 1 and 2, and may be made of silicone, for example. A further example of embodiment of the protective tube 3 is shown in FIGS. 3 to 5.

The protective tube 3 has a plurality of reinforcement ribs 4, which, located side by side around its circumference, extend parallel to its longitudinal direction. In the example of embodiment of FIGS. 1 and 2, the reinforcement ribs 4 extend over the majority of the protective tube 3, for example over three quarters of its length or more. The reinforcement ribs increase the mechanical load-bearing capacity of the protective tube 3, and are preferably dimensioned such that they can support the connector plug 10 on a cylinder head bore of an engine. In addition, the space between the reinforcement ribs 4 facilitates air exchange in the cylinder head bore. At least one of the said reinforcement ribs 4 has a predetermined bending point formed by at least one recess 5.

The protective tube 3 can, for example, have four reinforcement ribs 4, wherein two of the said reinforcement ribs 4 each have predetermined bending points located opposite each other and formed by a recess 5. The two reinforcement ribs 4 located in between them have no recesses in the corresponding position. If the protective tube 3 is curved, one of the said two recesses 5 forming a predetermined bending point is then located on the inside of the curve and the opposing recess 5 is located on the outside of the curve. The recess 5 on the inside of the curve avoids compressive stresses in the reinforcement rib 4. The recess 5 located on the outside of the curve avoids tensile stresses in the corresponding reinforcement rib 4. The reinforcement ribs 4 without recesses located between the said two reinforcement ribs 4 with recesses 5 are only slightly affected by the curvature shown in FIG. 2 and therefore do not require any recesses 5.

In the example of embodiment shown, the recesses 5 have a rectangular shape, but can also be of a different shape, for example they can be wedge-shaped or U-shaped.

At a distance from the predetermined bending points formed by the recesses 5, the protective tube 3 has a section 6 with an increased wall thickness. The increased wall thickness can be thickened up to the height of the reinforcement ribs, as shown in FIG. 1, but can also protrude beyond, or be thinner than, the outer diameter of the reinforcement ribs, so that reinforcement ribs can also be formed in region 6. In this manner, the mechanical stability of the protective tube 3 can be improved. In section 7 of the protective tube 3 containing the recesses 5, the wall thickness between the reinforcement ribs 4 can be significantly reduced so as to save material and facilitate the bending of the protective tube 3.

The recesses 5 of the reinforcement ribs 4 are preferably not so deep that an opening is thereby created in the protective tube 3. The recesses 5 of the reinforcement ribs 4 are preferably approximately as deep as the height of the reinforcement rib. The remaining wall thickness must be thick enough to provide the necessary protection and insulation.

The width of the recess 5 or recesses 5 measured in the longitudinal direction of the reinforcement ribs 4 is preferably as large as, or larger than, the width of the reinforcement ribs 4 measured transversely to their longitudinal direction, but is not more than three times the width of the reinforcement ribs 4.

The width of the recess (measured at rib height) may approach zero on the outer radius of the bend; a narrow slot or cut may be sufficient, as the recess diverges during bending. The recess is preferably slightly wider, so that a bending radius can form at the base of the recess. On the inside of the bend, the width of the recess should be dimensioned so that, during bending, the inner walls of the recess do not come into contact with each other, or only with a low contact pressure.

Only a single recess 5 is shown in FIG. 1. However, a plurality of recesses 5 can also be provided on a reinforcement rib 4.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SYMBOLS

1 End of connector plug adjacent to ignition coil
2 End of connector plug adjacent to spark plug
3 Protective tube
4 Reinforcement rib
5 Recess
6 Protective tube section
7 Protective tube section
10 Connector plug

What is claimed is:

1. A connector plug for connecting an ignition coil to a spark plug, comprising:
an electrical conductor having a first end configured for contacting the ignition coil and a second end configured for contacting the spark plug; and
a protective tube surrounding the electrical conductor;
wherein the protective tube has a predetermined bending point with a reduced bending stiffness.

2. The connector plug in accordance with claim 1, wherein the protective tube has a plurality of reinforcement ribs extending in a longitudinal direction thereof, and wherein the predetermined bending point comprises a recess in one or a plurality of the reinforcement ribs.

3. The connector plug in accordance with claim 2, wherein one or more of the reinforcement ribs has no recess for reducing the bending stiffness.

4. The connector plug in accordance with claim 3, wherein the protective tube has four reinforcement ribs, wherein two opposing reinforcement ribs have a predetermined bending point comprising a recess, and two reinforcement ribs have no recess.

5. The connector plug in accordance with claim 2, wherein the width of the recess, measured in the longitudinal direction of the reinforcement ribs, is equal to or greater than the width of the reinforcement ribs measured transversely to their longitudinal direction.

6. The connector plug in accordance with claim 5, wherein the width of the recess measured in the longitudinal direction of the reinforcement ribs is not more than three times the width of the reinforcement ribs measured in their longitudinal direction.

7. The connector plug in accordance with claim 1, wherein the outer surface of the protective tube is closed in the vicinity of the predetermined bending point.

8. The connector plug in accordance with claim 1, wherein the protective tube has a section at a distance from the predetermined bending point in which its wall thickness is increased around its periphery.

9. A protective tube for a connector plug for connecting an ignition coil to a spark plug, wherein the protective tube has a predetermined bending point with a reduced bending stiffness.
